(19) United States
(12) Patent Application Publication
(10) Pub. No.: US 2001/0053979 A1
(43) Pub. Date: Dec. 20, 2001

(54) COPYRIGHT PROTECTING METHOD OF DIGITAL DATA AND PROTECTING SYSTEM THEREOF

(75) Inventor: TERUHIKO KORI, KANAGAWA (JP)

Correspondence Address: FROMMER LAWRENCE & HAUG, 745 FIFTH AVENUE- 10TH FL., NEW YORK, NY, 10151, US

(73) Assignee: SONY CORPORATION

(21) Appl. No.: 08/935,756

(22) Filed: Sep. 23, 1997

(30) Foreign Application Priority Data
Sep. 27, 1996 (JP) P08-277130

(51) Int. Cl. G06F 17/60

(52) U.S. Cl. 705/1

(57) ABSTRACT

Copyright information is stored as property information of a file in a header portion of the file. The copyright information is composed of copy generation restriction information of a file. With a predetermined encrypting key kc, the copyright information is encrypted. When the file is accessed, the copyright information is extracted from the header portion. Unless the user who accesses the file has the encrypting key kc, he or she cannot decrypt the copyright information. Thus, A/V data stored in the file cannot be read. When a file is copied, the generation restriction information is rewritten and stored as copyright information. Thus, the copy generation can be restricted. When the A/V data itself is encrypted with another encrypting key kd and the key kd is encrypted with the key kc along with the copyright information, the copyright of the file can be more securely protected.

### BACKGROUND OF THE INVENTION

1. Field of the Invention

The present invention relates to a copyright protecting method of digital data and a protection system thereof for encrypting copyright information as property information of a data file in a predetermined manner so as to protect the copyright of digital data created as a literary work.

2. Description of the Related Art

In recent years, high speed computers, recording mediums with large storage capacities, computer networks, and picture compressing technologies have been spectactularly developed. Thus, digitized video signals and audio signals or computer graphics works are recorded as A/V (Audio/Video) data files. These A/V data files are reproduced as CD-ROMs or sold or distributed through networks.

The A/V data files are handled by for example personal computers. The users can reproduce and enjoy the A/V data files with display units and audio units connected to the personal computers.

Conventionally, so-called A/V units handle record mediums on which digitized video signals and audio signals are recorded. The conventional A/V units are categorized as reproduction only units and record/reproduction units. In the A/V data handled by the A/V units, by adding copyright information to A/V data recorded on the record mediums, the copyright can be relatively easily protected.

In contrast, A/V data files handled by personal computers do not have a system that protects copyright unlike with A/V data handled by A/V units. Thus, since the A/V data files are freely copied and edited, the infringement of copyright has stridden.

### OBJECTS AND SUMMARY OF THE INVENTION

Therefore, an object of the present invention is to provide a copyright protecting method of digital data and a protecting system thereof for protecting copyright of an A/V data file corresponding to copyright information of the A/V data file handled by a computer.

To solve the above-described problem, a first aspect of the present invention is a copyright protecting method for created digital data, comprising the steps of (a) encrypting copyright information with a first encrypting key, (b) storing the encrypted copyright information in a predetermined region of a file, (c) accessing the file and decrypting the encrypted copyright information, and (d) protecting copyright of the file corresponding to the decrypted copyright information.

To solve the above-described problem, a second aspect of the present invention is a copyright protecting system for created digital data, comprising an encrypting means for encrypting copyright information with a first encrypting key, a copyright information storing means for storing the encrypted copyright information in a predetermined region of a file, an accessing and decrypting means for accessing the file and decrypting the encrypted copyright information, and a copyright protecting means for protecting copyright of the file corresponding to the decrypted copyright information.

As described above, according to the present invention, copyright information that has been encrypted and stored in a predetermined region of a film is decrypted. The file is copyright-protected with the decrypted copyright information. Thus, the copyright information cannot be illegally rewritten by the user or the like. Consequently, the copyright of data can be securely protected.

These and other objects, features and advantages of the present invention will become more apparent in light of the following detailed description of a best mode embodiment thereof, as illustrated in the accompanying drawings.

### BRIEF DESCRIPTION OF THE DRAWINGS

FIG. 1 is a schematic diagram showing the structure of a system according to the present invention;

FIG. 2 is a table showing an example of the structure of an A/V data file according to an embodiment of the present invention;

FIGS. 3A and 3B are tables showing examples of CGMS information and APS information;

FIG. 4 is a flow chart showing a process for restricting a copy generation with the CGMS information;

FIG. 5 is a schematic diagram showing a process transition performed among software, OS, and A/V data file in the case that the A/V data file is stored;

FIG. 6 is a schematic diagram showing an example of a method for encrypting copyright information;

FIG. 7 is a schematic diagram showing an example of a method for decrypting copyright information;

FIG. 8 is a block diagram showing an encrypting method and a decrypting method for copyright information;

FIG. 9 is a flow chart showing a process for accessing a file in consideration of compatibility with an OS that corresponds to a copyright protecting system;

FIG. 10 is a schematic diagram showing a method for converting data in the case that an A/V data file is output to the outside;

FIG. 11 is a table showing an example of the structure of an A/V data file according to a modification of the present invention;

FIG. 12 is a schematic diagram showing an example of a method for encrypting an A/V data file with a user management key ku;

FIG. 13 is a schematic diagram showing an example of a method for decrypting an A/V data file with a user management key ku; and

FIG. 14 is a schematic diagram showing a process transition performed among software, OS, and A/V data file in the case that OS does not correspond to copyright information process.

### DETAILED DESCRIPTION OF THE PREFERRED EMBODIMENTS

Next, an embodiment of the present invention will be described. According to the present invention, an A/V data file handled by a computer has copyright information as property information. Since the copyright information has been encrypted and written to the A/V data file, the copyright information is prevented from being rewritten with an editor or the like. The encrypted copyright information is referenced when data is read from the A/V data file.

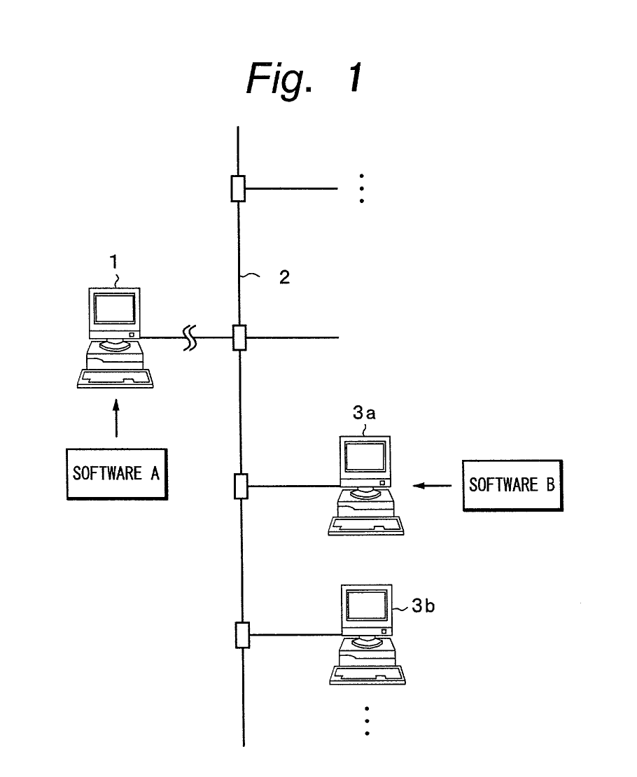

FIG. 1 is a schematic diagram showing the structure of a system according to the present invention. In this embodiment, to a predetermined network 2, a system of which a computer 1 that sends an A/V data file (this computer is referred to as a sending computer) and computers 3a, 3b, . . . , and so forth that receive an A/V data file (these computers are referred to as receiving computers) are connected is considered. As with the receiving side, a plurality of computers that send A/V data files can be connected. These computers 1, 3a, 3b, . . . , and so forth operate on a predetermined OS (Operating System). As will be described later, the OS has a function corresponding to the copyright protecting system of an embodiment of the present invention.

An A/V data file created by the sending computer 1 with predetermined application software A (hereinafter referred to as software A) is received by receiving computers 3a, 3b, . . . , and so forth through a network 2. The A/V data file is read by the computer 3a with predetermined application software B (hereinafter referred to as software B). The software A may be the same application software as the software B.

The above-described structure is just an example. Thus, the present invention can be also applied to a structure of which a personal computer that has a DVD (Digital Versatile Disc)—ROM drive and a digital VTR (Video Tape Recorder) are connected.

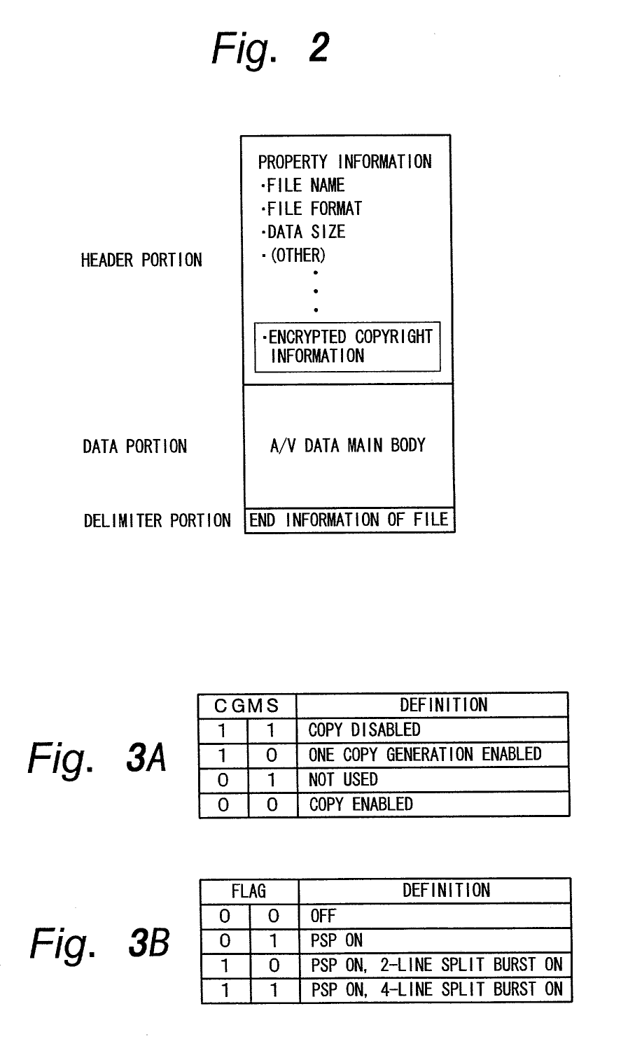

FIG. 2 is a table showing an example of the structure of an A/V data file according to an embodiment of the present invention. The A/V data file has a header portion, a data portion, and a delimiter portion.

The header portion is a region of which property information of the data file is written. The property information is composed of for example the file name, file format, and data size with wich software and OS identify the file. In addition, according to the embodiment, the property information contains encrypted copyright information. The OS and software A or B read the copyright information and protect the copyright of the file corresponding to the copyright information. Since the copyright information is stored as property information of the file, the copyright information cannot be deleted.

The data portion stores the A/V data main body, namely audio data and/or video data. The data portion may store for example a program and a script as well as the A/V data main body. In addition, the data portion can store both A/V data and programs. The delimiter portion stores for example the end information of the file.

According to the present invention, the above-described copyright information is composed of copy generation restriction control information (CGMS: Copy Generation Management System) and information with which the copy restricting system controls an analog video signal (APS: Analog Protection System). The copyright information may contain information such as copyright owner and data of creation with which the owner of data declares copyright and information such as a password and ID with which the owner of the data is identified. FIGS. 3A and 3B show examples of the CGMS information and the APS information. As shown in FIG. 3A, the CGMS information is composed of two bits. The CGMS information is defined as follows.

00: Copy enabled

01: Not used

10: One copy generation enabled

11: Copy disabled

The OS and software that handle the A/V data file read and reference the CGMS information and determine whether or not the file can be stored.

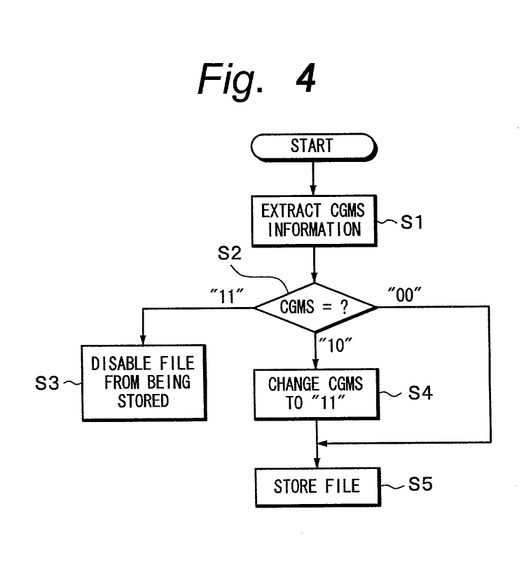

FIG. 4 is a flow chart showing a process for restricting a copy generation with the CGMS information. When a file containing the CGMS information is tried to be copied, the header portion of the file is read and thereby the CGMS information contained in the copyright information is extracted at step S1. At step S2, it is determined what is the CGMS information. When the CGMS information is “00”, the flow advances to step S5. At step S5, because of “COPY ENABLED”, the file is copied and stored.

When the CGMS information is “11” that represents “COPY DISABLED” at step S2, the flow advances to step S3. At step S3, corresponding to the definition, the file is prohibited from being stored.

When the CGMS information is “10” that represents “ONE COPY GENERATION ENABLED” at step S2, the flow advances to step S4. At step S4, the CGMS information is changed from “10” to “11” that represents “COPY DISABLED”. When the CGMS information is changed, the flow advances to step S5. At step S5, the file is copied and stored. Since the CGMS information has been changed to “11”, the file is prohibited from being copied. Thus, the copy generation is restricted.

In reality, when the file is copied, the content of the file is temporarily read to a buffer memory or the like and then written to another region of a data storing medium such as a memory or a disc. Thus, the copying operation of the file can be treated as the storing operation of the file.

As shown in FIG. 3B, the APS information is composed of two bits as with the above-described CGMS information. The APS information is for example defined as follows.

00: APS OFF

01: PSP ON, split burst OFF

10: PSP ON, 2-line split burst ON

11: PSP ON, 4-line split burst ON

The APS information is superimposed with an analog video signal in a predetermined manner and sent to for example an external video tape recorder and a television monitor. When these units correspond to the APS information, a copy prohibition signal generated corresponding to the analog copy restriction signal generated corresponding to the definition can disturb these units from recording and outputting the video signal.

In the case of “APS OFF”, an analog copy restriction signal is not generated. In the case of “PSP ON”, the system that superimposes the copy prohibition signal containing a pseudo synchronous signal with the analog video signal is activated. When this system is activated, the AGC of the video tape recorder to which the video signal is supplied is malfunctioned, thereby disturbing a normal picture from being recorded.

“SPLIT BURST ON” represents that the system that adds a color burst signal in which part of a reverse burst signal is inserted to the analog video signal is activated. When this system is activated, the APC of the monitor and the video tape recorder to which the video signal is supplied does not normally operate, thereby disturbing a normal picture from being displayed. “SPLIT BURST ON” is categorized as “2 LINE SPLIT BURST” of which a reverse burst signal is added at intervals of two lines and “4 LINE SPLIT BURST” of which a reverse burst signal is added at intervals of four lines. One of “2 LINE SPLIT BURST” and “4 LINE SPLIT BURST” is selected and activated.

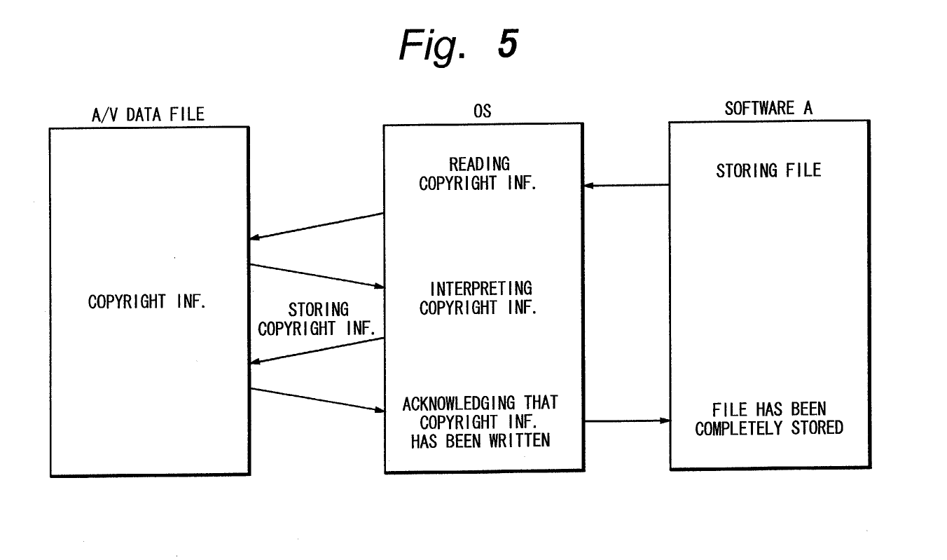

FIG. 5 shows a process transition performed among the software A, the OS 11, and the A/V data file 12 in the case that an A/V data file is stored. The A/V data file 12 is initially stored in a memory (not shown). When a storing operation for the file 12 is requested to the software A, the file 12 in the memory is stored on a record medium (not shown) such as a hard disc. This operation applies to a copying operation for an A/V data file from a first region to a second region of the hard disc and a storing operation of A/V data received through a network.

In the computers of this example, individual devices such as memory and hard disc are accessed by the software through the OS 11. A storing operation of the created A/V file 12 is requested to the software A. This request is sent from the software A to the OS 11 in a predetermined format. A key kc of the software A is sent to the OS 11. The OS 11 reads copyright information of the A/V data file stored in the memory. As will be described later, since the copyright information has been encrypted, it is decrypted in a predetermined manner.

The CGMS information is extracted from the decrypted copyright information. According to the flow chart shown in FIG. 4, it is determined whether or not the A/V data file 12 can be stored. When the A/V data file 12 can be stored, the A/V data file 12 is written and stored at a predetermined region of the hard disc. The OS 11 acknowledges that the file 12 has been written. The acknowledgment information is sent to the software A. Thus, the software A determines that the file 12 has been correctly stored.

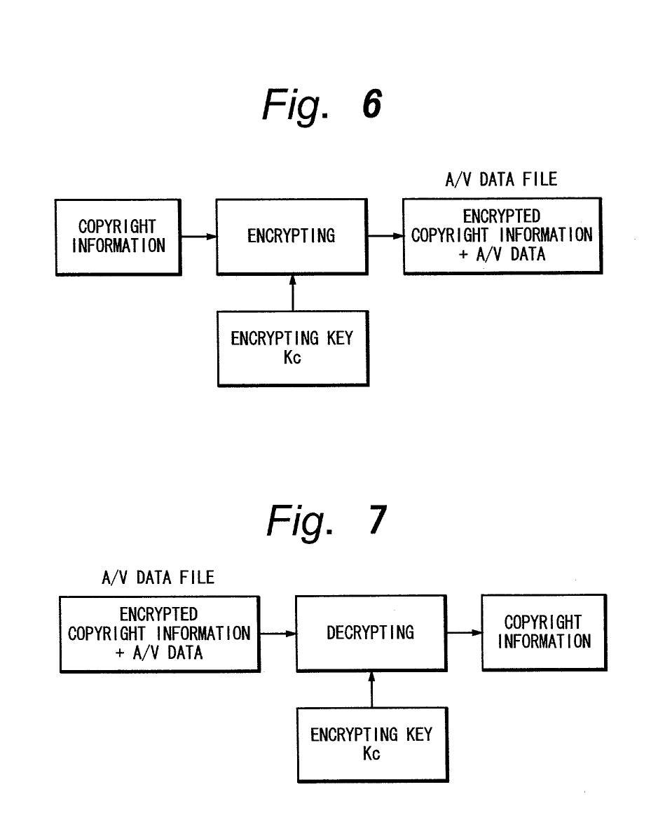

The user may easily rewrite the copyright information of the header portion with for example an editor that can edit binary data. To prevent that, according to the present invention, as described above, the copyright information is encrypted in a predetermined method. FIG. 6 shows an example of a method for encrypting copyright information. For example, as the software A creates A/V data, it creates copyright information. The copyright information contains copyright related information of A/V data (stored in the file such as copyright owner and date of creation) and the above-described CGMS information.

The copyright information is encrypted corresponding to a copyright key kc composed of a predetermined character string. The encrypting key kc depends on particular software. For example, the encrypting key kc is created corresponding to a password Pw of the user that is input to the software A that creates the above-described A/V data file and the software B that reads, reproduces, or executes the created file. Alternatively, these software may have the key kc.

As an encrypting method with the key kc, a symbol string or a character string that composes copyright information is processed in such a manner that the order of symbols or characters is changed or symbols or characters are converted into other ones. The encrypted copyright information is stored in the header portion as property information. In addition, the created A/V data is stored in the data portion. Thus, an A/V data file is created.

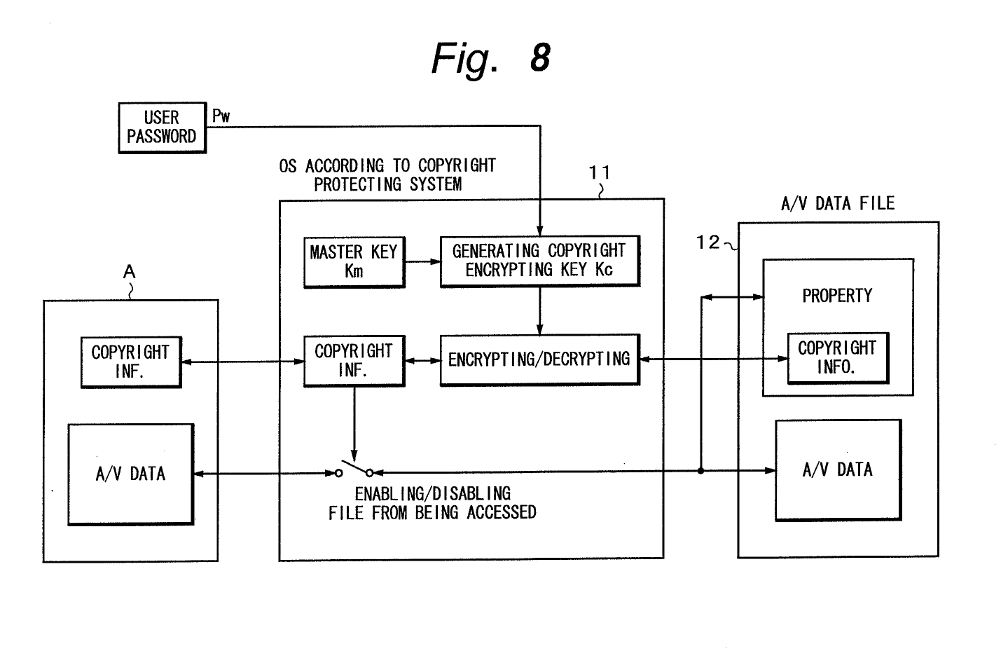

As shown in FIG. 7, the encrypted copyright information contained in the A/V data file is decrypted in the reverse manner of the encrypting method with the key kc. In other words, the software B reads property information stored in the header portion of the A/V data file. Thus, the encrypted copyright information contained in the property information is extracted. The key kc that the software B has had is used. With the key kc, the encrypted copyright information is decrypted in a predetermined manner. The above-described copy generation restricting process with the CGMS information is performed to the decrypted copyright information.

The encrypting/decrypting methods for the copyright information shown in FIGS. 6 and 7 are theoretical examples. Thus, these methods can be also applied to modifications that follow as well as the above-described embodiment.

FIG. 8 is a schematic diagram showing an encrypting method and a decrypting method for copyright information shown in FIGS. 6 and 7. In this example, the encrypting key kc with which copyright information is encrypted is created by the OS 11 with the user password Pw and the master key km.

The user password Pw is composed of a predetermined character string designated for the user. On the OS 11, the user password Pw is designated to the user who logs in. Alternatively, the password can be designated by the software A. When the OS 11 has designated the password Pw, whenever the OS 11 is activated, the user is prompted for the password Pw. When the software A has designated the password Pw, whenever the software A is activated, the user is prompted for the password Pw. The master key km is composed of a predetermined character string. For example, the master key km is designated when the OS 11 is installed to the computer 1.

The OS 11 reads the encrypted copyright information from the property information of the header portion of the A/V data file 12. The OS 11 decrypts the copyright information with the key kc. The CGMS information is extracted from the decrypted copyright information. It is determined whether or not the file 12 is enabled/disabled from being stored with the CGMS information.

In this case, it is determined whether the file 12 is disabled or enabled from being accessed corresponding to the decrypted copyright information. When the password Pw has been designated to the software A, the copyright information is sent to the software A. The software A collates the password Pw with the copyright information and sends the result to the OS 11.

On the other hand, the software A designates the CGMS information corresponding to the A/V data. When the A/V data file is stored, the OS 11 encrypts the copyright information with the key kc.

According to the embodiment of the present invention, the OS 11 performs the collating process and rewriting process for the CGMS information so as to protect copyright of an A/V data file. The OS 11 designates copyright information to all created files. When the OS 11 handles the files, it collates the designated copyright information for all the created files. In addition, files that have been created on another OS that does not correspond to the copyright protecting system should have compatibility with the copyright protecting system according to the present invention.

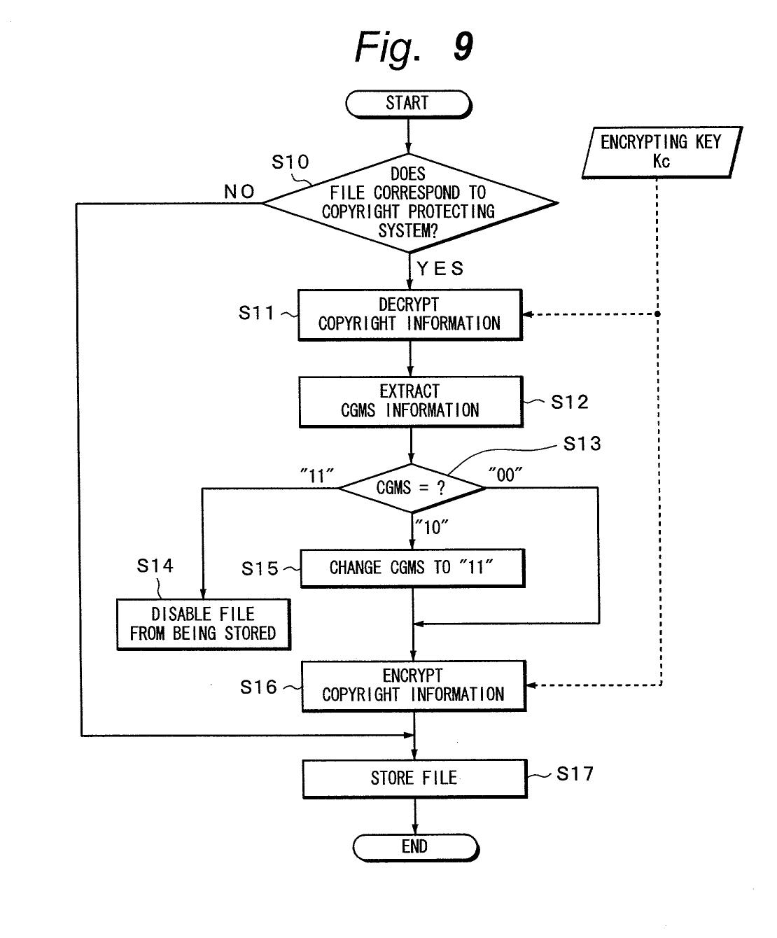

FIG. 9 is a flow chart showing a process for accessing a file in consideration of compatibility with an OS that corresponds to a copyright protecting system. When the file is accessed, it is determined whether or not the OS on which the file has created corresponds to the copyright protecting system at step S10. For example, when the file corresponds to the copyright protecting system, the OS 11 determines whether the header portion has a flag that represent that the file corresponds to the copyright protecting system. Alternatively, the OS 11 may determine whether or not the header portion has copyright information.

When the determined result at step S10 is No, the process for protecting the copyright of the file is not performed. In this case, the flow advances to step S17. At step S17, the file is stored.

In contrast, when the determined result at step S10 is Yes, the flow advances to step S11. At step S11, the copyright information is read from the file and decrypted. The decrypting process is performed in the following manner. The OS 11 requests predetermined software (for example, software A or B) for an encrypting key kc. With the received encrypting key kc, the copyright information is decrypted. After the copyright information has been decrypted, the flow advances to step S12.

At step S12, the CGMS information is extracted from the decrypted copyright information. At step S13, the value of the CGMS information is determined. When CGMS=“11”, the flow advances to step S14. At step S14, according to the definition of the CGMS information, the file is disabled from being stored. When CGMS=“00”, according to the definition, the file is enabled from being stored. Thus, the flow advances to step S16. When CGMS=“10”, the flow advances to step S15. At step S15, the CGMS information is rewritten to “11”. Thereafter, the flow advances to step S16.

At step S16, the copyright information is encrypted in the following manner. The OS 11 requests particular software for an encrypting key kc. With the received key kc, the copyright information is encrypted. After the copyright information has been encrypted, the copyright information contained in the header portion of the file becomes the encrypted copyright information at step S16. At step S17, this file is stored.

In the above description, the computers 1, 3a, 3b, . . . , and so forth connected to the network 2 have the same OS 11. However, the present invention is not limited to such a structure. In other words, even if the computers 1, 3a, 3b, . . . , and so forth have different OSs, as long as the computers 1, 3a, 3b, and so forth can communicate with each other using a common protocol, the copyright protecting system according to the present invention can be applied thereto.

In the flow chart shown in FIG. 9, the compatibility of files that do not correspond to the copyright protecting system is considered. However, by applying this process, a file that does not require copyright protection can be selectively designated.

The A/V data file is not only copied as a data file, but reproduced or executed by a computer. In addition, the A/V data file may be output as an analog video signal or a digital video signal. The output video signal is recorded by for example an analog video tape recorder. Thus, the copyright of the A/V data may be infringed. Consequently, the copyright protection in this case should be considered.

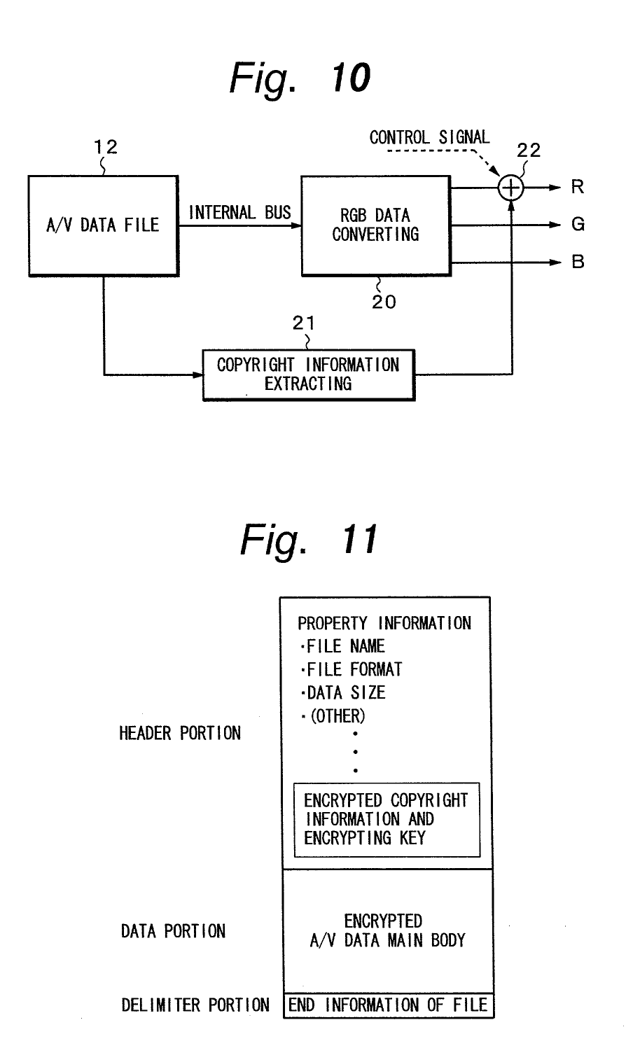

FIG. 10 theoretically shows a method for converting data in the case that A/V data reproduced from an A/V data file is output to the outside of the computer. In this example, the A/V data is converted into analog RGB signals. The software A reproduces the A/V data file 12 and outputs the A/V data. The A/V data is supplied to an encoder 20. The encoder 20 converts the digital signals into analog signals that are for example component video signals. For example, an R signal of the component video signals is supplied to a first input terminal of an adding device 22.

The adding device 22 adds a signal received from a second input terminal and the video signal received from the first input terminal in synchronization with the video signal. In other words, a control signal created corresponding to a timing signal with which the A/V data is converted into the video signal is supplied to the adding device 22.

On the other hand, the software A or the OS 11 reads the copyright information from the A/V data file. With a key kc, the copyright information is decrypted. Thus, APS information is extracted. Corresponding to the APS information, an analog copy restriction signal is generated. The generated signal is supplied to the second input terminal of the adding device 22. The adding device 22 adds the signal to for example a vertical blanking interval of the R signal that has been input from the first input terminal.

The analog video signal is supplied to the monitor and displayed thereon. In addition, the analog video signal is supplied to a RGB signal/composite video signal converting unit corresponding to the APS information. Since the copy restriction signal is superimposed in the blanking interval, it does not affect the picture displayed on the monitor. However, when the copy restriction signal is output to the outside as a composite video signal through the RGB signal/composite video signal converting unit that corresponds to the APS information, the copy protection signal corresponding to the definition of the APS information as shown in FIG. 3B is superimposed with or added to the video signal. Thus, even if the video signal is recorded on a video tape or the like, it cannot be reproduced as a normal picture. Consequently, the copyright of the A/V data cannot be protected.

When the A/V data file is reproduced and output to the outside as digital picture data, CGMS information and APS information that are extracted from the copyright information are sent as they are. The GCMS information and the APS information are recorded at predetermined regions of a tape of a digital video cassette recorder. Thus, in this case, the copy protection can be easily performed.

Next, a modification of the embodiment of the present invention will be described. FIG. 11 shows an example of the structure of an A/V data file of the modification of the embodiment. In this modification, A/V data stored in the data portion is encrypted with a predetermined encrypting key kd. The key kd is encrypted corresponding to the copyright information of the header portion of the A/V data file and corresponding to a predetermined encrypting key. In the modification, the A/V data itself is encrypted so as to more securely protect the copyright of the A/V data.

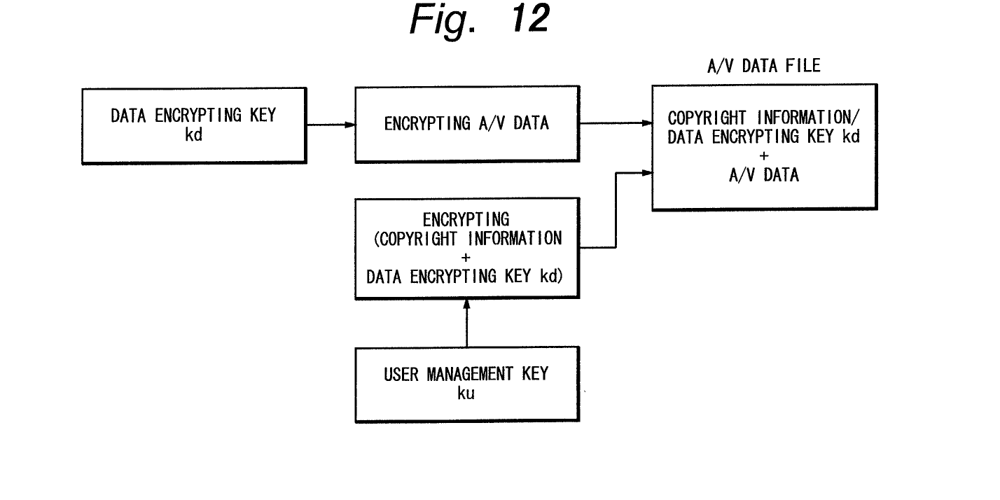

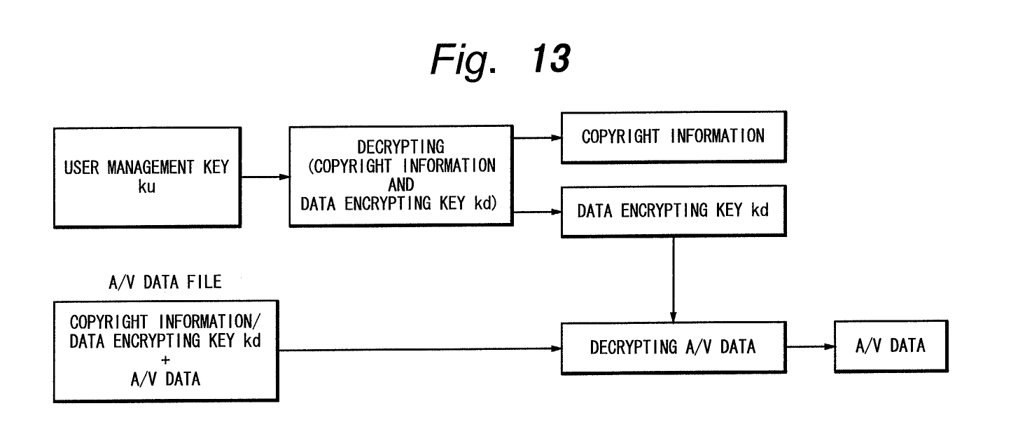

FIG. 12 is a schematic diagram showing a method for encrypting an A/V data file according to the modification of the embodiment. In this example, with a user management key ku supplied from the A/V data file supplying side to the user, copyright information and data encrypting key kd are encrypted.

The A/V data is encrypted with the data encrypting key kd managed by the data supplying side. In this encrypting method, characters are repeatedly changed and/or replaced corresponding to a predetermined rule with the key kd. The encrypted A/V data is stored in the data portion of the A/V data file. The key kd used for encrypting the A/V data is also encrypted corresponding to the user management key ku on the supplying side of the A/V data along with the copyright information. The user management key ku is designated for each user who receives the A/V data. The user management key ku is supplied from the A/V data supplying side to each user. The copyright information and key kd that have been encrypted is supplied as property information to the header portion of the A/V data file.

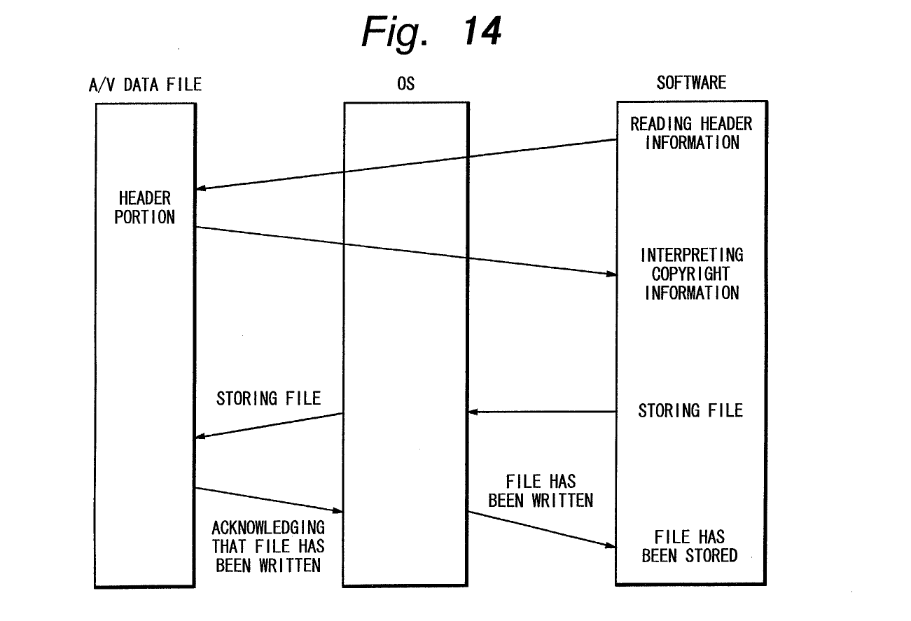

FIG. 13 is a schematic diagram showing an example of a method for decrypting an A/V data file according to the modification of the embodiment. The header portion is read from the A/V data file supplied from the A/V data supplying side to the user. Thus, encrypted copyright information and encrypted data encrypting key kd are extracted. A user management key ku is supplied from the A/V data supplying side to the user beforehand. The encrypted copyright information and the encrypted key kd that are extracted from the header portion are decrypted with the user management key ku. With the decrypted key kd, the encrypted A/V data stored in the data portion is decrypted.

With the user management key ku, the A/V data supplying side can restrict the user to use the A/V data file so as to manage the user. Thus, the method for using the user management key ku is suitable for A/V data files that are quantitatively created.

On the other hand, the method for protecting copyright according to the embodiment is suitable for protecting copyright of personal works.

In the modification, instead of the user management key ku, the encrypting key kc according to the embodiment can be used. In this case, however, the A/V data supplying side does not strictly manage the user.

In the above-described embodiment and modification thereof, the present invention is applied to the OS that corresponds to the copyright information process. However, the present invention is not limited to such a structure. FIG. 14 shows a process transition performed among software A′, an OS 11′, and an A/V data file 12 in the case that the present invention is applied to an OS that does not correspond to the copyright information process as a second modification of the present invention. The second modification can be applied to the file structures of the embodiment and the first modification thereof.

In the second modification, unlike with the first modification, the software A′ reads copyright information from an A/V data file and decrypts the copyright information unlike with the OS 11 in the above-described embodiment and the first modification thereof. The A/V data file 12 is initially stored in a memory (not shown). When a storing operation for the file 12 is requested to the software A′, the file 12 is stored in a hard disc (not shown). The present invention is not limited to this example. In other words, the present invention can be applied to a copying operation for copying an A/V file from a first region to a second region of the hard disc or a storing operation for storing A/V data received through a network.

A storing operation for storing the created A/V data file 12 is requested to the software A′. Thus, property information is read from the header portion of the A/V data file 12. Copyright information is extracted from the property information that has been read. The copyright information has been encrypted with a unique encrypting key kc of the software A. With the key kc, the copyright information is decrypted and interpreted.

The encrypting key used for encrypting the copyright information is not limited to the encrypting key kc. For example, a user management key ku supplied from the A/V data file supplying side to the user can be used as the encrypting key.

The CGMS information is extracted from the interpreted copyright information. Corresponding to the flow chart shown in FIG. 4, it is determined whether or not the A/V data file 12 is enabled from being stored. When the A/V data is enabled from being stored, the OS 11′ writes and stores the A/V data file 12 to a predetermined region of for example a hard disc. The OS 11′ acknowledges that the file 12 has been written. The acknowledgment information is sent from the OS 11′ to the software A′. When the software A′ has received the information, the file 12 has been correctly stored.

As described above, according to the present invention, the property information of the A/V data file contains the copyright information for protecting copyright of the file. Thus, the copyright protecting system can be applied to A/V data handed by the computers. Thus, the copyright can be prevented from being infringed.

In addition, according to the present invention, the copyright information contains CGMS information for controlling a copy generation restriction for copyright information. In the same concept as the conventional digital A/V units, the copyright of A/V data can be protected. Thus, the concept of copyright protection for A/V data on computers is compatible with the concept of copyright protection of digital A/V units.

Moreover, according to the present invention, since copyright information has been encrypted, it is protected from being irregularly rewritten. Thus, high security can be obtained.

Furthermore, according to the present invention, when a file is updated or stored, the OS references property information that contains copyright information. Thus, in comparison with the case that the same process is performed by application software, the copyright protection can be securely performed.

Since the process for protecting the copyright is performed by software or OS with data of at most several bytes, the cost for the copyright protection can be almost ignored.

In addition, since the copyright information of the present invention can be handled as property information of an A/V data file, it cannot be deleted from the file. Thus, the copyright can be more securely protected.

Moreover, since the copyright information of the present invention is structured with the common concept to the copyright protection of digital A/V units, the A/V data of the present invention can be directly sent to the interface with the digital A/V units.

Although the present invention has been shown and described with respect to a best mode embodiment thereof, it should be understood by those skilled in the art that the foregoing and various other changes, omissions, and additions in the form and detail thereof may be made therein without departing from the spirit and scope of the present invention.

What is claimed is:

1. A copyright protecting method for created digital data, comprising the steps of:
(a) encrypting copyright information with a first encrypting key;
(b) storing the encrypted copyright information in a predetermined region of a file;
(c) accessing the file and decrypting the encrypted copyright information; and
(d) protecting copyright of the file corresponding to the decrypted copyright information.

2. The copyright protecting method as set forth in claim 1,
wherein the predetermined region is a region for storing property information of the file.

3. The copyright protecting method as set forth in claim 1,
wherein the copyright information is composed of information for restricting a copy generation of the file.

4. The copyright protecting method as set forth in claim 1,
wherein the copyright information is stored even if the file is processed in a predetermined manner.

5. The copyright protecting method as set forth in claim 1,
wherein the steps (a) to (d) are performed on predetermined application software.

6. The copyright protecting method as set forth in claim 1,
wherein the steps (a) to (d) are performed on an operating system.

7. The copyright protecting method as set forth in claim 1,
wherein when digital A/V data obtained by processing the file in the predetermined manner is converted into a signal of a different format, the copyright information is converted corresponding to the different format and the resultant copyright information is sent along with the signal of the difference format.

8. The copyright protecting method as set forth in claim 1, further comprising the steps of:
(e) encrypting a data main body of the file stored in the file with a second encrypting key; and
(f) decrypting the data main body with the second encrypting key,
wherein the step (e) is performed by encrypting the copyright information and the second encrypting key with the first encrypting key.

9. The copyright protecting method as set forth in claim 8,
wherein the steps (e) and (f) are performed on predetermined application software.

10. The copyright protecting method as set forth in claim 8,
wherein the steps (e) and (f) are performed on an operating system.

11. A copyright protecting system for created digital data, comprising:
encrypting means for encrypting copyright information with a first encrypting key;
copyright information storing means for storing the encrypted copyright information in a predetermined region of a file;
accessing and decrypting means for accessing the file and decrypting the encrypted copyright information; and
copyright protecting means for protecting copyright of the file corresponding to the decrypted copyright information.

12. The copyright protecting system as set forth in claim 11,
wherein the predetermined region is a region for storing property information of the file.

13. The copyright protecting system as set forth in claim 11,
wherein the copyright information is composed of information for restricting a copy generation of the file.

14. The copyright protecting system as set forth in claim 11,
wherein the copyright information is stored even if the file is processed in a predetermined manner.

15. The copyright protecting system as set forth in claim 11,
wherein predetermined application software has said encrypting means, said copyright information storing means, said decrypting means, and said copyright protecting means.

16. The copyright protecting system as set forth in claim 11,
wherein an operating system has said encrypting means, said copyright information storing means, said decrypting means, and said copyright protecting means.

17. The copyright protecting system as set forth in claim 11,
wherein when digital A/V data obtained by processing the file in the predetermined manner is converted into a signal of a different format, the copyright information is converted corresponding to the different format and the resultant copyright information is sent along with the signal of the difference format.

18. The copyright protecting system as set forth in claim 11, further comprising:
second encrypting means for encrypting a data main body of the file stored in the file with a second encrypting key; and
second decrypting means for decrypting the data main body with the second encrypting key,
wherein said second encrypting means encrypts the copyright information and the second encrypting key with the first encrypting key.

19. The copyright protecting system as set forth in claim 18,
wherein predetermined application software has said second encrypting means and said second decrypting means.

20. The copyright protecting system as set forth in claim 18,
wherein an operating system has said second encrypting means and said second decrypting means.
